(19) United States
(12) Patent Application Publication
(10) Pub. No.: US 2023/0320922 A1
(43) Pub. Date: Oct. 12, 2023

(54) Ergonomic Crutch with Underarm Shock Absorber Support

(71) Applicant: L'Chef LLC, St. George, UT (US)

(72) Inventor: Phillip Dietz, St. George, UT (US)

(21) Appl. No.: 17/717,242

(22) Filed: Apr. 11, 2022

(51) Int. Cl. A61H 3/02

(52) U.S. Cl. CPC A61H 3/0277; A61H 2003/0283

(57) ABSTRACT

An ergonomic crutch with underarm shock absorber support is provided. The crutch is designed to provide increased safety, security and comfort to a user. The crutch provides upper and lower support members, a hand grip support and an underarm support with a customizable core to accommodate users of varying height and weight. The shock absorber is in a position elevated from the walking surface which increases functionality and longevity.

### FIELD OF THE INVENTION

The present invention relates generally to mobility assistance devices, and more particularly, to an ergonomic crutch with underarm shock absorber support.

### BACKGROUND OF THE INVENTION

Crutches are known in the art and are an effective means for supporting a user while walking. Traditional crutch designs incorporate similar structural configurations including a frame, an underarm support member and a hand grip member.

Various problems exist with the use of traditional crutches such as discomfort, fatigue and strain on other areas of a user's body. These problems may prevent the user from using a crutch for prolonged periods of time and may cause issues such as inconvenience and risk of injury. Traditional crutch designs can cause pain and discomfort due to lack of proper support and configuration appropriate for a user's particular height or weight. Some crutch users attempt to remedy these problems by creating makeshift modifications to a crutch which can further exacerbate the problems and cause other safety concerns.

Therefore, there exists a need in the art for an ergonomic crutch with underarm shock absorber support that can provide increased safety, security, support and comfort to the crutch user.

### SUMMARY OF THE INVENTION

The disclosure of the present application comprises an ergonomic crutch with underarm shock absorber support having a hollow body, a lower support member, and upper support member and in internal shock absorber. The crutch further includes an underarm support member and an underarm support core. The lower support member and upper support member may be adjusted to increase or decrease the length of the crutch and the underarm support core exchanged for cores of various sizes and durometers to accommodate the height and weight of different users.

### BRIEF DESCRIPTION OF THE DRAWINGS

FIG. 1 illustrates a front view of an ergonomic crutch with underarm shock absorber support of the present invention showing the crutch in a fully extended position.

FIG. 2 illustrates a front view of the crutch showing the crutch in a fully retracted position.

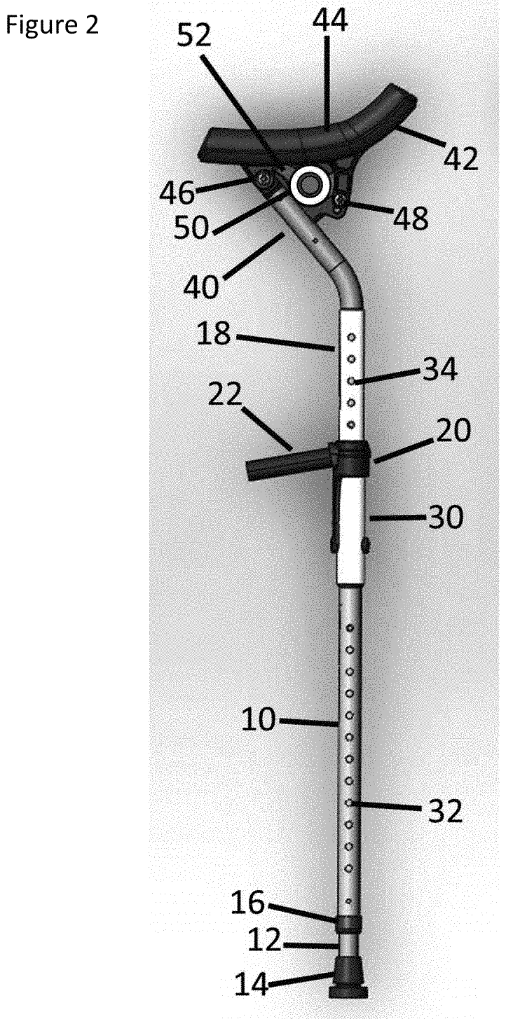

FIG. 3 illustrates an internal view of the crutch showing a shock absorber inside a hollow body portion of the crutch.

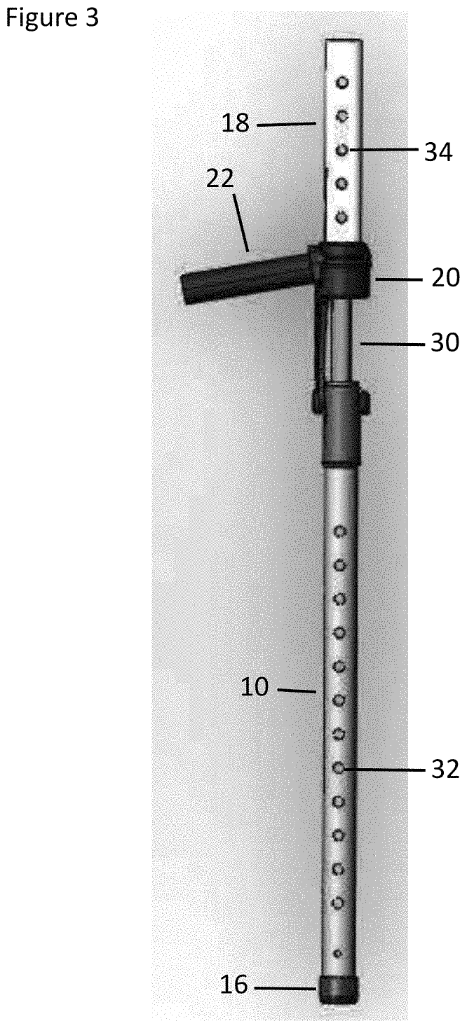

It will be appreciated that the drawings are illustrative and not limiting of the scope of the invention which is defined by the appended claims. The embodiments shown accomplish various aspects and objects of the invention. It is appreciated that it is not possible to clearly show each element and aspect of the invention in a single figure, and as such, multiple figures are presented to separately illustrate the various details of the invention in greater clarity.

### DETAILED DESCRIPTION OF THE INVENTION

Reference will now be made in detail to the presently preferred embodiments of the invention. There are also representative examples of the invention illustrated in the accompanying drawings. Throughout the following detailed description, the same reference numeral refers to the same elements in all figures.

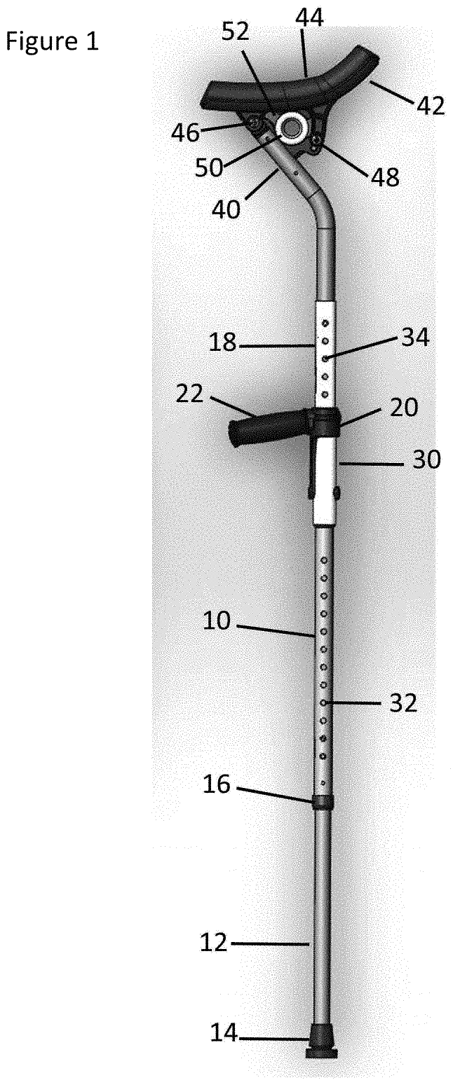

The present invention provides an ergonomic crutch with underarm shock absorber support that aids a user while walking. Referring to FIG. 1, there is a hollow body 10, having a lower end 16 and an upper end 18. A lower support member 12 is housed inside the lower end 16 and configured to extend and retract adjusting the length of the crutch to accommodate users of varying heights. The lower support member 12 locks in position via a lower locking mechanism 32. A tip 14 is disposed on the lower support member 12 to provide additional stability and traction while the crutch is in use.

A hand grip support 20 is affixed to a section of the hollow body 10 and a hand grip 22 is disposed on the hand grip support 20 providing stability and control to the crutch user while walking. There is a shock absorber 30 disposed inside a portion of the hollow body 10 configured to absorb a user's weight.

An upper support member 40 is housed inside the upper end 18 and configured to extend and retract adjusting the length of the crutch. The upper support member 40 extends away from the hollow body 10 at about a 45° angle and locks in position via an upper locking mechanism 34. An underarm support member 42 is connected to the upper support member 40 at an angle substantially perpendicular to the hollow body 10. An underarm cushion 44 is disposed on the underarm support member 42 to provide additional comfort and support to the user. The underarm support member 42 includes a first pivot point 46 and a second pivot point 48 forming an aperture 52 between the upper support member 40 and the underarm support member 42. A removeable underarm support core 50 is housed inside the aperture 52.

The underarm support core 50 may be substantially circular shape. The underarm support core 50 may be replaced by other cores of varying sizes and durometers to accommodate users of different size and weight. The underarm support core 50 also helps keep the underarm support member 42 substantially perpendicular to the hollow body 10 and substantially parallel to a walking surface.

The underarm cushion 44 may be elevated and suspended above the underarm support member 42 and made of a foam with flexible urethane core, or the like, for increased comfort. The underarm support member 42 may include attached ends of a rigid urethane support with some spring to flex and allow more movement that adapts to the user.

It should be appreciated that a unique feature of the present disclosure is that shock absorber 30 is housed in a portion of hollow body 10 and is elevated from the walking surface. This helps keep the shock mechanism out of snow, puddles, dirt and the like to maximize its functionality and increase its longevity. Another feature considered unique to the present disclosure is the ability to remove the lower support member 12 and upper support member 42 and replace with other members of various functions and features for additional customization of the crutch.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. An ergonomic crutch comprising:
a crutch body having upper and lower ends;
a lower support member securable at various locations along the crutch body via a locking mechanism, said lower support member comprising a traction tip;
a hand grip support;
an underarm support pivotably connected to the upper end of the crutch body and wherein pivoting action between the underarm support and the upper end of the crutch body defines a pivoting action space;
a force dampener disposed in the pivoting action space.

2. The ergonomic crutch of claim 1 wherein the force dampener is an elastomeric plug.

3. The ergonomic crutch of claim 1 wherein the pivoting action space is arcuate.

4. The ergonomic crutch of claim 1 wherein the pivoting action space is trapezoidal.

5. An ergonomic crutch comprising:
a midsection body having upper and lower ends;
a lower support member configured for insertion into the lower end of the midsection body and securable at various locations via a lower locking mechanism, said lower support member comprising a traction tip;
a hand grip support;
an upper support member configured for insertion into the upper end of the midsection body;
an underarm support pivotably connected to the upper support member and wherein pivoting action between the underarm support and the upper support member defines a pivoting action space;
a force dampener disposed in the pivoting action space.

6. The ergonomic crutch of claim 5 wherein a portion of the upper support member is configured at an angle to the midsection body.

7. The ergonomic crutch of claim 6 wherein a portion of the upper support member is configured at an angle of about 45° to the midsection body.

8. The ergonomic crutch of claim 7 wherein the force dampener is an elastomeric plug.

9. An ergonomic crutch comprising:
a midsection body having upper and lower ends and a hollow mid-portion;
a lower support member configured for insertion into the lower end of the midsection body and securable at various locations via a lower locking mechanism, said lower support member comprising a traction tip;
a hand grip support;
an upper support member configured for insertion into the upper end of the midsection body;
an underarm support pivotably connected to the upper support member and wherein pivoting action between the underarm support and the upper support member defines a pivoting action space;
a first force dampener disposed in the pivoting action space;
a second force dampener disposed within the hollow mid-portion of the midsection body and in communication with the upper support member.

10. The ergonomic crutch of claim 9 wherein the first force dampener is an elastomeric plug.

11. The ergonomic crutch of claim 9 wherein the second force dampener is a gas shock absorber.

12. The ergonomic crutch of claim 9 wherein the first force dampener is an elastomeric plug and the second force dampener is a gas shock absorber.
